(19) United States
(12) Patent Application Publication
(10) Pub. No.: US 2017/0179732 A1
(43) Pub. Date: Jun. 22, 2017

(54) Dynamic Tuning for Harvesting Energy from Current Transformers

(71) Applicants: BRUCE DOUGLAS HOEPPNER, BROOKFIELD, WI (US); DENIS STERJO, CUDAHY, WI (US); RICHARD WILLIAM LUCAS, ZIMMERMAN, MN (US); GREGG JAMES HAENSGEN, MENOMONEE FALLS, WI (US)

(72) Inventors: BRUCE DOUGLAS HOEPPNER, BROOKFIELD, WI (US); DENIS STERJO, CUDAHY, WI (US); RICHARD WILLIAM LUCAS, ZIMMERMAN, MN (US); GREGG JAMES HAENSGEN, MENOMONEE FALLS, WI (US)

(73) Assignee: COOPER TECHNOLOGIES COMPANY, HOUSTON, TX (US)

(21) Appl. No.: 14/978,727

(22) Filed: Dec. 22, 2015

(51) Int. Cl. H02J 5/00; H01F 38/32

(52) U.S. Cl. CPC H02J 5/005; H01F 38/32

(57) ABSTRACT

An energy harvesting system can include an electrical conductor through which primary power flows. The system can also include an instrument transformer disposed around the electrical conductor, where the instrument transformer includes a secondary inductor, where the instrument transformer creates a first transformed power through the secondary inductor using the first power. The system can also include at least one tuning capacitor electrically coupled in parallel to the secondary inductor. The system can further include at least one switch coupled in series with the at least one tuning capacitor, where the at least one switch has an open position and a closed position. The system can also include an electrical load electrically coupled to the secondary inductor and the at least one switch, where the at least one tuning capacitor modifies the first transformed power when the at least one switch is in the closed position.

### TECHNICAL FIELD

Embodiments described herein relate generally to energy harvesting, and more particularly to systems, methods, and devices for dynamic tuning for harvesting energy from current transformers.

### BACKGROUND

Instrument transformers are commonly used for metering and measurement purposes. The most common types of instrument transformers are current transformers and voltage transformers. The instrument transformer has a primary winding and a secondary winding wrapped around the primary winding. In the case of a current transformer, the primary winding is disposed around an electrical conductor through which high levels of current flow. In the case of a voltage transformer, the primary winding is electrically coupled to two points that measure high levels of voltage. The ratio of turns of the primary winding relative to turns of the secondary winding dictate the voltage or current in the secondary winding.

### SUMMARY

In general, in one aspect, the disclosure relates to an energy harvesting system. The energy harvesting system can include an electrical conductor through which primary power flows. The energy harvesting system can also include an instrument transformer disposed around the electrical conductor, where the instrument transformer includes a secondary inductor, where the instrument transformer creates a first transformed power through the secondary inductor using the first power. The energy harvesting system can further include at least one tuning capacitor electrically coupled in parallel to the secondary inductor. The energy harvesting system can also include at least one switch coupled in series with the at least one tuning capacitor, where the at least one switch has an open position and a closed position, where the closed position allows the at least one tuning capacitor to remain electrically coupled to the secondary inductor, and where the open position electrically decouples the at least one tuning capacitor from the secondary inductor. The energy harvesting system can further include an electrical load electrically coupled to the secondary inductor and the at least one switch, where the at least one tuning capacitor modifies the first transformed power when the at least one switch is in the closed position, where the electrical load operates using the first transformed power.

In another aspect, the disclosure can generally relate to a system for dynamically tuning energy harvested from an instrument transformer. The system can include a main capacitor configured to be electrically coupled in parallel to a secondary inductor of the instrument transformer. The system can also include a first tuning capacitor electrically coupled in parallel to the main capacitor. The system can further include a first switch coupled in series with the first tuning capacitor, where the first switch has an open position and a closed position, where the closed position allows the first tuning capacitor to remain electrically coupled to the main capacitor, and where the open position electrically decouples the first tuning capacitor from the main capacitor. The main capacitor and the secondary inductor can create a first transformed voltage delivered to an electrical load. The main capacitor, the first tuning capacitor, and the secondary inductor can create a second transformed voltage delivered to the electrical load.

In yet another aspect, the disclosure can generally relate to a dynamic tuning system. The system can include at least one tuning capacitor configured to be electrically coupled in parallel to a secondary inductor and an energy transfer device, where the secondary inductor is part of an instrument transformer disposed around an electrical conductor through which primary power flows, where the instrument transformer creates a transformed power through the secondary inductor using the first power. The system can also include at least one switch coupled in series with the at least one tuning capacitor, where the at least one switch has an open position and a closed position, where the closed position allows the at least one tuning capacitor to remain electrically coupled to the secondary inductor, and where the open position electrically decouples the at least one tuning capacitor from the secondary inductor. The energy transfer device can process the first transformed power as modified by the at least one tuning capacitor. The at least one switch can operate between the closed position and the open position based on at least one characteristic of the transformed power.

These and other aspects, objects, features, and embodiments will be apparent from the following description and the appended claims.

### BRIEF DESCRIPTION OF THE DRAWINGS

The drawings illustrate only example embodiments of dynamic tuning for harvesting energy from current transformers and are therefore not to be considered limiting of its scope, as dynamic tuning for harvesting energy from current transformers may admit to other equally effective embodiments. The elements and features shown in the drawings are not necessarily to scale, emphasis instead being placed upon clearly illustrating the principles of the example embodiments. Additionally, certain dimensions or positionings may be exaggerated to help visually convey such principles. In the drawings, reference numerals designate like or corresponding, but not necessarily identical, elements.

FIG. 1 shows a general system diagram of dynamic tuning for harvesting energy from current transformers in accordance with certain example embodiments.

FIG. 2 shows a detailed system diagram of dynamic tuning for harvesting energy from current transformers in accordance with certain example embodiments.

FIG. 3 shows a circuit diagram of an energy harvesting system in accordance with certain example embodiments.

FIG. 4 shows a system diagram of an electrical system in accordance with certain example embodiments.

FIG. 5 shows a computing device in accordance with certain example embodiments.

### DETAILED DESCRIPTION OF EXAMPLE EMBODIMENTS

The example embodiments discussed herein are directed to systems, apparatuses, and methods of dynamic tuning for harvesting energy from current transformers. While example embodiments are described herein as being directed to current transformers, example embodiments can also be used with any other type of instrument transformer, including but not limited to potential transformers (also called voltage transformers). As described herein, a user can be any person that interacts with instrument transformers and/or energy harvesting systems. Examples of a user may include, but are not limited to, a consumer, an electrician, an engineer, a lineman, a consultant, a contractor, an instrumentation and controls technician, an operator, and a manufacturer's representative.

In one or more example embodiments, a system for harvesting energy is subject to meeting certain standards and/or requirements. Examples of entities that set and/or maintain such standards can include, but are not limited to, the International Electrotechnical Commission (IEC), the National Electric Code (NEC), the National Electrical Manufacturers Association (NEMA), and the Institute of Electrical and Electronics Engineers (IEEE). Example embodiments are designed to be used in compliance with any applicable standards and/or regulations.

As described herein, communication between two or more components of an example energy harvesting system is the transfer of any of a number of types of signals. Examples of signals can include, but are not limited to, power signals, control signals, communication signals, data signals, instructions, and status reporting. In other words, communication between components of example energy harvesting system can involve the transfer of power (e.g., high levels of current, high levels of voltage), control (e.g., low voltage, low current), and/or data.

Any example energy harvesting systems, or portions (e.g., features) thereof, described herein can be made from a single piece or component (as from a single integrated circuit). Alternatively, an example energy harvesting system (or portions thereof) can be made from multiple pieces or components. While instrument transformers have polarities, the orientation of an instrument transformer used with example embodiments can be flexible, regardless of polarity.

Any component described in one or more figures herein can apply to any subsequent figures having the same label. In other words, the description for any component of a subsequent (or other) figure can be considered substantially the same as the corresponding component described with respect to a previous (or other) figure. The numbering scheme for the components in the figures herein parallel the numbering scheme for corresponding components described in another figure in that each component is a three digit number having the identical last two digits. For any figure shown and described herein, one or more of the components may be omitted, added, repeated, and/or substituted. Accordingly, embodiments shown in a particular figure should not be considered limited to the specific arrangements of components shown in such figure.

Example embodiments of energy harvesting systems will be described more fully hereinafter with reference to the accompanying drawings, in which example energy harvesting systems are shown. Energy harvesting systems may, however, be embodied in many different forms and should not be construed as limited to the example embodiments set forth herein. Rather, these example embodiments are provided so that this disclosure will be thorough and complete, and will fully convey the scope of energy harvesting systems to those of ordinary skill in the art. Like, but not necessarily the same, elements (also sometimes called components) in the various figures are denoted by like reference numerals for consistency.

Terms such as “first” and “second” are used merely to distinguish one component (or part of a component or state of a component) from another. Such terms are not meant to denote a preference or a particular orientation. Also, the names given to various components described herein are descriptive of one embodiment and are not meant to be limiting in any way. Those of ordinary skill in the art will appreciate that a feature and/or component shown and/or described in one embodiment (e.g., in a figure) herein can be used in another embodiment (e.g., in any other figure) herein, even if not expressly shown and/or described in such other embodiment.

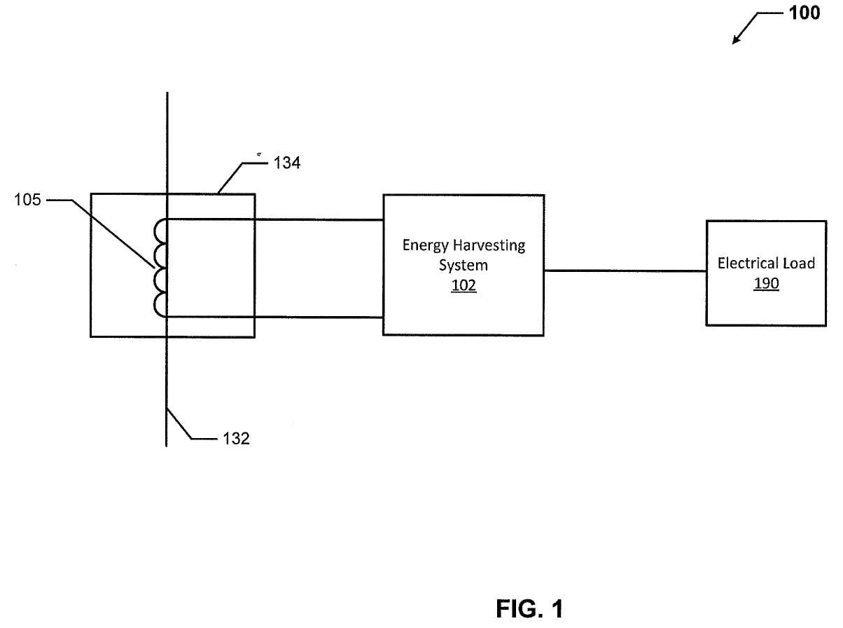

FIG. 1 shows a general system 100 of dynamic tuning for harvesting energy from current transformers in accordance with certain example embodiments. The system 100 of FIG. 1 can include an electrical conductor 132 with a current transformer 134 disposed around the electrical conductor 132. The current transformer 134 includes a secondary inductor 105 that is electrically coupled to an example energy harvesting system 102. In turn, the energy harvesting system 102 is electrically coupled to an electrical load 190.

The current transformer 134 (also called a CT 134 herein) can also include a primary inductor (also called a primary winding or a core) around which the secondary inductor 105 (also called a secondary winding) can be wrapped one or more times. The core of the CT 134 can be made of one or more of a number of different materials, including but not limited to steel, ferrite (iron), and composite. When the core of the CT 134 is steel, a number of benefits can be realized. For example, the steel core can more effectively measure line currents flowing through the electrical conductor 102, detect fault signatures in the electrical conductor 102, and allow for more efficient and consistent energy harvesting by example embodiments described herein.

The core of the CT 134 can have any of a number of configurations. For example, the core of the CT 134 can be solid. Alternatively, the core of the CT 134 can be split (as with a clamp-on CT). As yet another alternative, the core of the CT 134 can be flexible. When the CT 134 has a solid core, the position of the CT 134 around the electrical conductor 132 is, for all practical purposes, permanent. By contrast, when the CT 134 has a split core, the CT 134 can easily be disposed around and removed from the electrical conductor 132. In this way, the CT 134 with a split core can be moved by a user from one location to another (e.g., from being disposed around one electrical conductor 132 to being disposed around another electrical conductor 132) with relative ease. In any case, the impedance of the CT 134 can change with the frequency of the power induced therein.

As defined herein, an electrical conductor 132 includes a wire or strand of wires made of one or more of a number of electrically conductive materials (e.g., copper, aluminum). The wire or strand of wires of the electrical conductor 132 can be encased, in whole or in part, by a jacket or casing that is made of one or more of a number of electrically non-conductive materials (e.g., rubber, plastic). In some cases, the electrical conductor 132 can include a ground shield disposed around or within the jacket or casing. The wire or strand of wires of the electrical conductor 132 can have a size (e.g., 12 AWG, 8 AWG) appropriate for the amount of power that is designed to flow through the electrical conductor 132. The electrical conductor 132 can be part of an electrical cable that has one or more other electrical conductors 132. Alternatively, the electrical conductor 132 can be its own electrical cable. The electrical conductor 132 can be used in any of a number of applications where power is transferred from one electrical device to another. An example of such an application can include, but is not limited to, a capacitor bank. The electrical conductor 132 can have little to no voltage connected to it. Alternatively, the electrical conductor 132 can have hundreds, thousands, or even tens of thousands of volts connected to it. In any case, some amount of current flows through the electrical conductor 132.

The current that flows through the electrical conductor 132 can have any frequency (e.g., 60 Hz), including multiples (second, third) of a harmonic. For example, a third harmonic of approximately 180 Hz can be present in current flowing through the electrical conductor 132. In some example embodiments, multiples of a harmonic (e.g., 180 Hz) are dominant over a base or fundamental frequency (e.g., 60 Hz). The various characteristics (e.g., amount, frequency, harmonics) of the current flowing through the electrical conductor 132 (and so also the secondary inductor 105) can vary over time or can be substantially consistent over time. In the former case, example energy harvesting systems 102 (and, in particular, the dynamic tuning system of the energy harvesting systems 102, described below) can dynamically analyze the various characteristics of the current flowing through the secondary inductor 105, determine the most prominent characteristic at that point in time, and make adjustments so that characteristic is used when harvesting energy for the electrical load 190.

When power flows through the electrical conductor 132, the power induces a magnetic field in the core of the CT 134. When the magnetic field flows through the core, an electrical current is induced in the secondary inductor 105 wrapped around the core of the CT 134. The amount of current that is induced in the secondary inductor 105 of the CT 134 relative to the amount of current flowing through the electrical conductor 132 is based on the number of times that the secondary inductor 105 is wrapped around the core of the CT 134. This is also called a turns ratio of the CT 134. Example turns ratios can include, but are not limited to, 800:1, 5000:1, 2000:1, and 400:5. If the turns ratio of the CT 134 is 1000:5, then a 10 A current flowing through the electrical conductor 132 will result in a 0.05 A current flowing through the secondary inductor 105 of the CT 134.

At times, the current (e.g., in terms of amount, in terms of frequency) flowing through the electrical conductor 132 can vary widely. As a result, the current that flows through the secondary inductor 105 can also vary widely. When current that flows through the secondary inductor 105 is being harvested to create energy for use by the electrical load 190, this variation can cause problems. For example, when the current that flows through the electrical conductor 132 (and so also through the secondary inductor 105) is low compared to a normal current level, efficiency is lost. As another example, when the current that flows through the electrical conductor 132 is high compared to a normal current level, the electrical load 190 can overheat, resulting in failure.

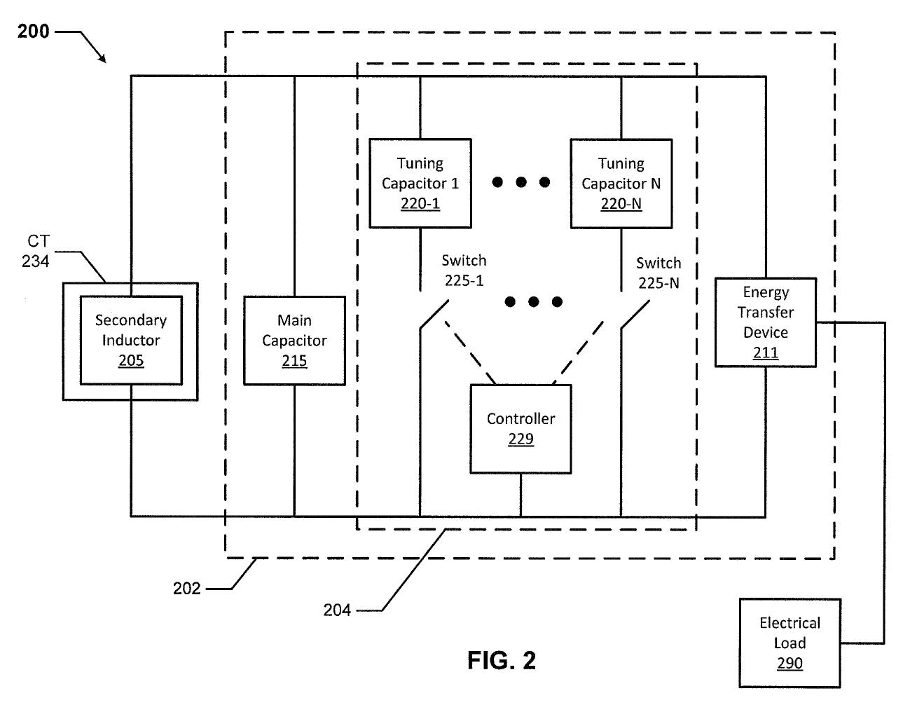

Conditions within the electrical load 190 can also affect the quality of the harvested energy. For example, if the demand of the electrical load 190 is not constant, then there can be energy lost and/or inefficiencies. Further, variations in the CT 134 (e.g., non-uniformity of the secondary inductor 105) can also affect the quality and consistency of the power harvested. As a result, example energy harvesting systems 102 are used to provide a more reliable, stable source of harvested power for the electrical load 190 by dynamically adjusting impedance between the CT 134 and the electrical load 190. The electrical load 190 can include one or more of a number of electrical devices. Such electrical devices can include, but are not limited to, an energy storage device (e.g., a battery), a light source (e.g., a light-emitting diode), a radio, and a hardware processor. Details of an example energy harvesting system 102 are described below with respect to FIG. 2.

FIG. 2 shows a detailed system 200 of dynamic tuning for harvesting energy from current transformers in accordance with certain example embodiments. The secondary inductor 205 and the electrical load 290 of FIG. 2 are substantially the same as the secondary inductor 105 and the electrical load 190 described above with respect to FIG. 1. The components of the energy harvesting system 202 of FIG. 2 are merely an example embodiment.

In example embodiments, the circuit from which the current is being harvested is largely inductive (from the secondary inductor 105) with some resistance. As a result, the energy harvesting system 202, and the example dynamic tuning system 204 in particular, uses largely capacitive control to dynamically match impedance of the system 200 for improved (e.g., maximum) power transfer to the electrical load 290. The example energy harvesting system 202 can include one or more of a number of components. For example, as shown in FIG. 2, the energy harvesting system 202 can include a main capacitor 215, a dynamic tuning system 204, and an energy transfer device 211.

In certain example embodiments, the main capacitor 215 is one or more capacitors with a known capacitance that is electrically connected in parallel with the secondary inductor 205. If there are multiple capacitors that make up the main capacitor 215, those multiple capacitors can be connected in series and/or in parallel with respect to each other. The capacitance of the main capacitor 215 can be determined based on one or more of a number of factors, including but not limited to the turns ratio of the CT, the frequency (including any harmonics) of the power flowing through the secondary inductor 205, and the amount of current flowing through the secondary inductor 205. The main capacitor 215 can serve as a base capacitance in the LC circuit formed with the secondary inductor 205 and any contributing tuning capacitors (described below). In some cases, the energy harvesting system 202 may not have a main capacitor 215 and instead rely entirely on the tuning capacitors 220 of the dynamic tuning system 204 to provide the capacitance used to balance the inductive load within the system 200.

In certain example embodiments, the energy transfer device 211 receives the current flowing through the secondary inductor 205, the main capacitor 215, and the dynamic tuning system 204 and alters (e.g., transforms, converts, inverts) the current into a form of energy that can be used by the electrical load 290. The energy transfer device 211 can include one or more of a number of energy-transforming components (e.g., a transformer, a diode bridge, an inverter, a converter) that can alter the current received by the energy transfer device 211.

In certain example embodiments, the dynamic tuning system 204 is disposed between, and electrically in parallel with, the main capacitor 215, the secondary inductor 205, and the energy transfer device 211. The dynamic tuning system 204 can include one or more of a number of components. For example, as shown in FIG. 2, the dynamic tuning system 204 can include one or more tuning capacitors 220 (e.g., tuning capacitor 1 220-1, tuning capacitor N 220-N), one or more switches 225 (e.g., switch 1 225-1, switch N 225-N), and an optional controller 230.

In certain example embodiments, each tuning capacitor 220 is one or more capacitors with a known capacitance that is electrically connected in series with one of the switches 225. Each tuning capacitor 220 is also electrically connected in parallel with the other tuning capacitors 220, if any. If there are multiple capacitors that make up a particular tuning capacitor 220, those multiple capacitors can be connected in series and/or in parallel with respect to each other. The capacitance of a tuning capacitor 220 can be determined based on one or more of a number of factors, including but not limited to the turns ratio of the CT, the frequency (including any harmonics) of the power flowing through the secondary inductor 205, the capacitance of the main capacitor 215, and the amount of current flowing through the secondary inductor 205.

In certain example embodiments, a tuning capacitor 220 can include one or more components aside from, or in addition to, one or more capacitors. For example, a tuning capacitor 220 can include one or more inductors (also called tuning inductors). In such a case, a configuration of inductors and capacitors, in series and/or in parallel with respect to each other, can form a tuning capacitor 220.

Each of the switches 225 is designed to have an open state and a closed state. When a switch 225 is an open state, the tuning capacitor 220 that is connected in series with that switch 225 is effectively removed (electrically decoupled) from the energy harvesting system 202. When a switch 225 is a closed state, the tuning capacitor 220 that is connected in series with that switch 225 is effectively included in (electrically coupled to) the energy harvesting system 202. In other words, if a switch 225 is closed, the capacitance of the corresponding tuning capacitor 220 is added to the capacitance of the main capacitor 215 as well as the capacitance of any other tuning capacitor 220, if any, whose corresponding switch 225 is also closed at a point in time. If there is no main capacitor 215, then one or more of the tuning capacitors 220 can perform the role of the main capacitor 215.

In certain example embodiments, each switch 225 operates independently of the other switches 225 in the dynamic tuning system 204. Alternatively, two or more switches 225 can operate jointly. A switch 225 can be any component and/or device that can change between an open state and a closed state based on any of a number of conditions. A switch 225 can be a physical device, part of an integrated circuit, software code, and/or any other suitable kind of switch. Examples of a switch 225 can include, but are not limited to, a MOSFET, a FET, a contactor, a relay, a dipole switch, a logic gate, and a digital gate.

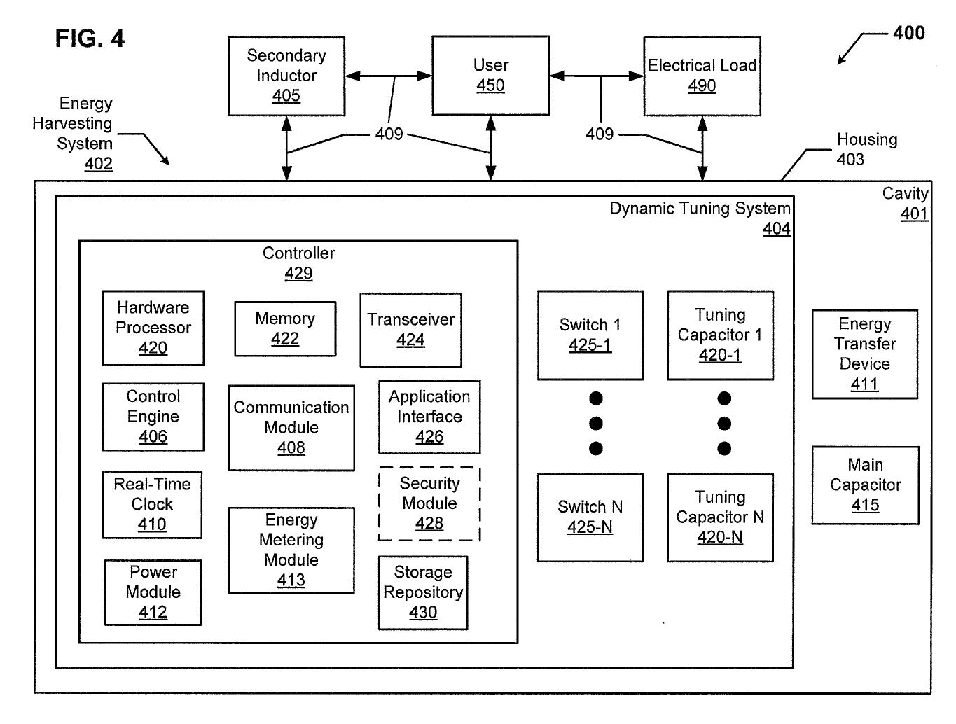

A switch 225 can be controlled (e.g., operated between a closed state and an open state) by any of a number of devices and/or components. For example, as explained in more detail below with respect to FIG. 4, one or more of the switch 225 can be controlled by a controller 229. As another example, one or more of the switches 225 can be controlled using a form of discrete automatic gain control. In any case, any one or more of the switches 225 can operate dynamically, based on the characteristics of the current flowing through the secondary inductor 205 at a point in time, so that the power delivered by the energy transfer device 211 to the electrical load 290 is relatively consistent and useful for the electrical load 290.

As stated above, example dynamic tuning systems 204 are used to provide a more reliable, stable source of harvested power for the electrical load 290 by dynamically adjusting impedance between the CT 234 and the electrical load 290. This can be important, for example, when harmonics become prominent in the power flowing through the CT 234. Put another way, example dynamic tuning systems 204 are used to raise the voltage level of the energy harvesting system 202 high enough, in view of the highest level harmonic flowing through the secondary inductor 205, to create energy sufficient for use by the electrical load 290.

In certain example embodiments, the CT 234, the dynamic tuning system 204, and/or the energy harvesting system 202 can be easily disconnected from adjacent components of the system by a user. For example, the energy harvesting system 202 can be unplugged from the CT 234 and the electrical load 290. In other words, example embodiments can be modular, portable, and interchangeable. In this way, example embodiments can be used to augment existing systems, either as an add-on to the existing system or by being integrated with the existing system. Alternatively, different instrument transformers can be used with example embodiments at different times.

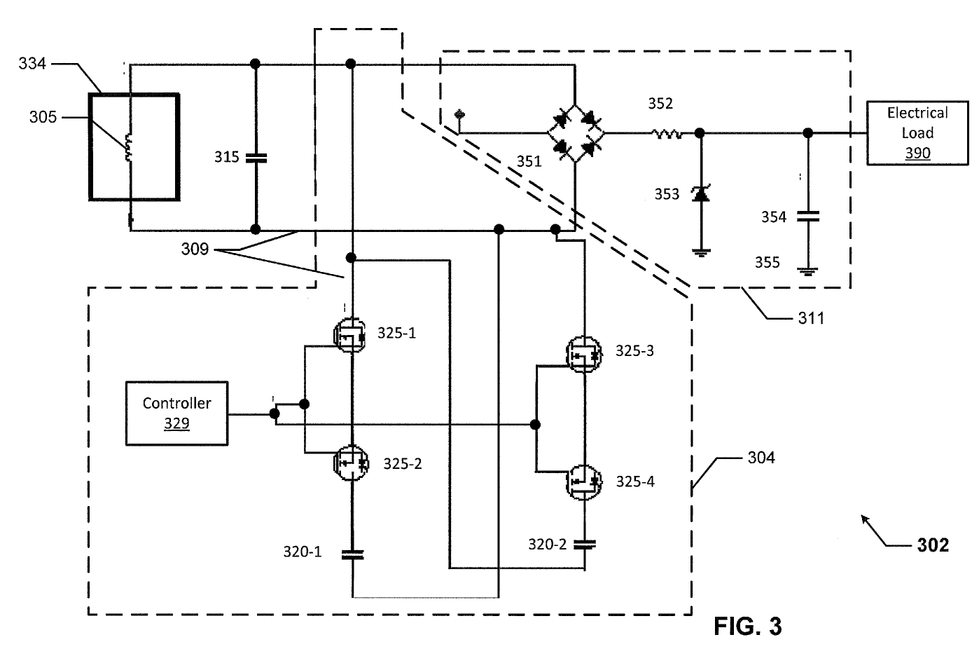

FIG. 3 shows a circuit diagram of an energy harvesting system 302 in accordance with certain example embodiments. In this case, details of an example embodiment of the dynamic tuning system 304 and an energy transfer device 311 are shown. For the example dynamic tuning system 304 of FIG. 3, there are four switches 325 in the form of MOSFETs, and there are two tuning capacitors 320. Switch 325-1 and switch 325-2 control whether tuning capacitor 320-1 is electrically coupled in parallel to the main capacitor 315, and switch 325-3 and switch 325-4 control whether tuning capacitor 320-2 is electrically coupled in parallel to the main capacitor 315. The switches 325 in FIG. 3 are operated by the controller 329, the details of which are provided below with respect to FIG. 4.

In this case, the main capacitor 315 has a capacitance of 1 μF, and tuning capacitor 320-1 and tuning capacitor 320-2 each has a capacitance of 3 μF. As a result, when all four of the switches 325 in FIG. 3 are closed, the total capacitance is 7 μF. The energy transfer device 311 includes a diode bridge 351, a resistor 352 connected in series downstream from the diode bridge 351, and the electrical load 390 connected in series downstream from the resistor 352. Connected in parallel with the electrical load 390 is a Zener diode 353 and a capacitor 354, which are each connected to ground 355. In this case, the resistor 352 has a resistance of 1.5Ω, and the capacitor 354 has a capacitance of 220 ρF.

FIG. 4 shows a system diagram of an electrical system 400 in accordance with certain example embodiments. The electrical system 400 can include a secondary inductor 405, a user 450, an electrical load 490, and an energy harvesting system 402. The energy harvesting system 402 can include an energy transfer device 411, a dynamic tuning system 404, and a main capacitor 415. The dynamic tuning system 404 can include one or more of a number of components. For example, the dynamic tuning system 404 can include a controller 429, at least one switch 425 (e.g., switch 425-1, switch 425-N), and at least one tuning capacitor 420 (e.g., tuning capacitor 1 420-1, tuning capacitor 1 420-N). The controller 429 can include one or more of a number of components. Such components of the controller 429, can include, but are not limited to, a control engine 406, a communication module 408, a real-time clock 410, an energy metering module 413, a power module 412, a storage repository 430, a hardware processor 421, a memory 422, a transceiver 424, an application interface 426, and, optionally, a security module 428.

The components shown in FIG. 4 are not exhaustive, and in some embodiments, one or more of the components shown in FIG. 4 may not be included in an example energy harvesting system or components thereof. Any component of the example energy harvesting system 402 can be discrete or combined with one or more other components of the energy harvesting system 402. The energy harvesting system 402 can have a housing 403 inside or which one or more components (e.g., controller 429, tuning capacitors 420) are disposed. Alternatively, one or more of the components of the energy harvesting system 402 can be disposed on the housing 403. As yet another alternative, one or more of the components of the energy harvesting system 402 can be disposed outside of the housing 403.

The user 450 is the same as a user defined above. In addition, a user 450 can be a system, such as a network manager. The user 450 can use a user system (not shown), which may include a display (e.g., a GUI). The user 450 interacts with (e.g., sends data to, receives data from) the controller 429 of the dynamic tuning system 404 of the energy harvesting system 402 via the application interface 426 (described below). The user 450 can also interact with an electrical load 490 and/or the secondary inductor 405. Interaction between the user 450 and the energy harvesting system 402, the electrical load 490, and the secondary inductor 405 can be conducted using communication links 409.

Each communication link 409 can include wired (e.g., Class 1 electrical cables, Class 2 electrical cables, leads within a printed circuit board, electrical connectors) and/or wireless (e.g., Wi-Fi, visible light communication, cellular networking, Bluetooth, WirelessHART, ISA100, Power Line Carrier, RS485) technology. For example, a communication link 409 can be (or include) one or more electrical conductors that are coupled to the housing 403 of the energy harvesting system 402 and to a secondary inductor 405. The communication link 409 can transmit signals (e.g., power signals, communication signals, control signals, data) between the energy harvesting system 402 and the user 450, the electrical load 490, and/or the secondary inductor 405. The electrical load 490, the secondary inductor 405, main capacitor 415, the switches 425, and the tuning capacitors 420 of FIG. 4 are substantially to the corresponding components described above with respect to FIGS. 1 and 2.

The user 450, the electrical load 490, and/or the secondary inductor 405 can interact with the dynamic tuning system 404 of the energy harvesting system 402 using the application interface 426 in accordance with one or more example embodiments. Specifically, the application interface 426 of the dynamic tuning system 404 receives data (e.g., information, communications, instructions, updates to firmware) from and sends data (e.g., information, communications, instructions) to the user 450, the electrical load 490, and/or the secondary inductor 405. The user 450, the electrical load 490, and/or the secondary inductor 405 can include an interface to receive signals (e.g., power, communication, data) from and send signals to the dynamic tuning system 404 in certain example embodiments. Examples of such an interface can include, but are not limited to, a graphical user interface, a touchscreen, an application programming interface, a keyboard, a monitor, a mouse, a web service, a data protocol adapter, some other hardware and/or software, or any suitable combination thereof.

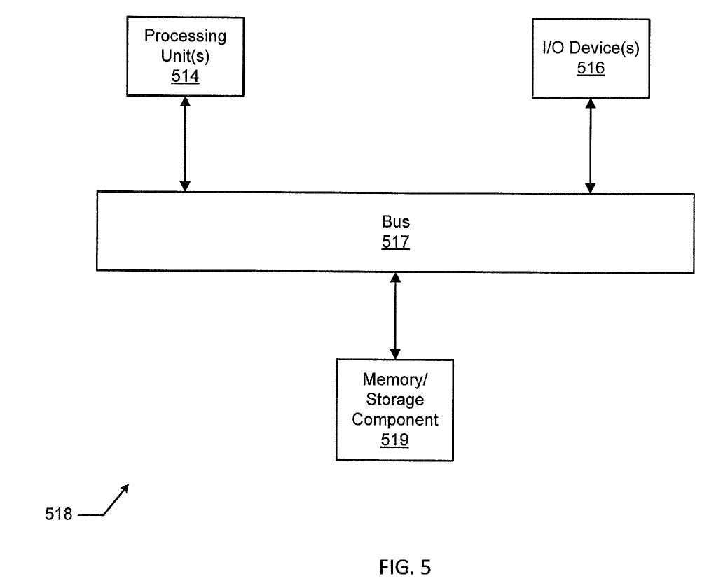

The dynamic tuning system 404, the user 450, the electrical load 490, and/or the secondary inductor 405 can use their own system or share a system in certain example embodiments. Such a system can be, or contain a form of an Internet-based or an intranet-based computer system that is capable of communicating with various software. A computer system includes any type of computing device and/or communication device, including but not limited to the dynamic tuning system 404. Examples of such a system can include, but are not limited to, a desktop computer with LAN, WAN, Internet or intranet access, a laptop computer with LAN, WAN, Internet or intranet access, a smart phone, a server, a server farm, an android device (or equivalent), a tablet, smartphones, and a personal digital assistant (PDA). Such a system can correspond to a computer system as described below with regard to FIG. 5.

Further, as discussed above, such a system can have corresponding software (e.g., user software, sensor software, controller software, network manager software). The software can execute on the same or a separate device (e.g., a server, mainframe, desktop personal computer (PC), laptop, personal desktop assistant (PDA), television, cable box, satellite box, kiosk, telephone, mobile phone, or other computing devices) and can be coupled by the communication network (e.g., Internet, Intranet, Extranet, Local Area Network (LAN), Wide Area Network (WAN), or other network communication methods) and/or communication channels, with wire and/or wireless segments according to some example embodiments. The software of one system can be a part of, or operate separately but in conjunction with, the software of another system within the system 400.

The energy harvesting system 402 can include a housing 403. The housing 403 can include at least one wall that forms a cavity 401. In some cases, the housing can be designed to comply with any applicable standards so that the energy harvesting system 402 can be located in a particular environment (e.g., a hazardous environment). For example, if the energy harvesting system 402 is located in an explosive environment, the housing 403 can be explosion-proof. According to applicable industry standards, an explosion-proof enclosure is an enclosure that is configured to contain an explosion that originates inside, or can propagate through, the enclosure.

The housing 403 of the energy harvesting system 402 can be used to house one or more components of the energy harvesting system 402, including one or more components of the dynamic tuning system 404. For example, as shown in FIG. 4, the dynamic tuning system 404 (which in this case includes the controller 429 (and all of its various components), the energy transfer device 411, the switches 425, the tuning capacitors 420, and the main capacitor 415 are disposed in the cavity 401 formed by the housing 403. In alternative embodiments, any one or more of these or other components of the energy harvesting system 402 can be disposed on the housing 403 and/or remotely from the housing 403.

The storage repository 430 can be a persistent storage device (or set of devices) that stores software and data used to assist the dynamic tuning system 404 in performing its functions and in communicating (e.g., sending signals to, receiving signals from) with the user 450, the electrical load 490, and the secondary inductor 405 within the system 400. For example, the storage repository 430 can store communication protocols, algorithms, and stored data. The communication protocols can be any of a number of protocols that are used to send and/or receive signals (e.g., data, power, control) between the dynamic tuning system 404 and the user 450, the electrical load 490, and the secondary inductor 405.

The algorithms can be any procedures (e.g., a series of method steps), formulas, logic steps, mathematical models, and/or other similar operational procedures that the Controller 429 of the dynamic tuning system 404 follows based on certain conditions at a point in time. An example of an algorithm is measuring (using the energy metering module 413), storing (using the stored data in the storage repository 430), and evaluating the power characteristics (e.g., frequency, current voltage) flowing through the secondary inductor 405 over time.

Algorithms can be focused on certain components of the energy harvesting system 402. For example, there can be one or more algorithms that focus on the impedance of the main capacitor 415 over time. As another example, there can be one or more algorithms the control the state (e.g., open, closed) of the various switches 425 based on the value of the corresponding tuning capacitor 420. As example, an algorithm can be to continuously monitor the current (as measured by the energy metering module 413 and stored as stored data) that flows through the secondary inductor 405 or the amount of charge being delivered to the electrical load 490 (e.g., an energy storage device).

Stored data can be any data associated with the energy harvesting system 402, any measurements taken by the energy metering module 413, threshold values, results of previously run or calculated algorithms, capacitance values of each of the tuning capacitors 420, speed of the switches 425, and/or any other suitable data. Such data can be any type of data, including but not limited to historical data for the energy harvesting system 402, calculations, and measurements taken by the energy metering module 413. The stored data can be associated with some measurement of time derived, for example, from the real-time clock 410.

Examples of a storage repository 430 can include, but are not limited to, a database (or a number of databases), a file system, a hard drive, flash memory, some other form of solid state data storage, or any suitable combination thereof. The storage repository 430 can be located on multiple physical machines, each storing all or a portion of the information (e.g., communication protocols, algorithms, stored data) according to some example embodiments. Each storage unit or device can be physically located in the same or in a different geographic location.

The storage repository 430 can be operatively connected to the control engine 406 of the controller 429. In one or more example embodiments, the control engine 406 includes functionality to communicate with the user 450, the electrical load 490, and the secondary inductor 405 in the system 400. More specifically, the control engine 406 sends information to and/or receives information from the storage repository 430 in order to communicate with the user 450, the electrical load 490, and the secondary inductor 405. As discussed below, the storage repository 430 can also be operatively connected to the communication module 408 in certain example embodiments.

In certain example embodiments, the control engine 406 of the controller 429 of the dynamic tuning system 404 controls the operation of one or more components (e.g., the communication module 408, the real-time clock 410, the transceiver 424) of the dynamic tuning system 404. For example, the control engine 406 can activate the communication module 408 when the communication module 408 is in “sleep” mode and when the communication module 408 is needed to send data received from another component (e.g., a secondary inductor 405, the user 450, the electrical load 490) in the system 400.

In certain example embodiments, the control engine 406 can operate in “sleep” mode while monitoring the power delivered to the electrical load 490. If the control engine 406 determines that the power is not sufficient for the electrical load 490, then the control engine 406 can become active and resume dynamically adjusting the switches 425. For example, if the electrical load 490 is a battery, and the harvested power is being used to charge the battery, the control engine 406 can be in sleep mode while monitoring whether the charge for the battery is sufficient. If not, the control engine 406 can activate and dynamically tune the system 404.

As another example, the control engine 406 can acquire the current time using the real-time clock 410. The real time clock 410 can help enable the dynamic tuning system 404 to control the switches 425 in order to provide substantially constant power to the energy transfer device 411 (and so also to the electrical load 490). As yet another example, the control engine 406 can direct the energy metering module 413 to measure one or more power characteristics (e.g., current, voltage, frequency, impedance) within the energy harvesting system 402. In some cases, the control engine 406 of the controller 429 of the dynamic tuning system 404 can control (e.g., open, close) one or more of the switches 425, which adjusts the total capacitance in parallel with the secondary inductor 405.

The control engine 406 can be configured to perform a number of functions that help harvest a substantially constant amount of power that is delivered to the energy transfer device 411 (and so also to the electrical load 490). To accomplish this, the control engine 406 can execute any of the algorithms stored in the storage repository 430. As a specific example, the Control engine 406 can measure (using the energy metering module 413), store (as stored data in the storage repository 430), and evaluate, using an algorithm, the frequency, current, and voltage of power flowing through the secondary inductor 405 over time.

The Control engine 406 can provide power, control, communication, and/or other suitable signals to the user 450, the electrical load 490, and/or the secondary inductor 405. Similarly, the control engine 406 can receive power, control, communication, and/or other similar signals from the user 450, the electrical load 490, and the secondary inductor 405. The control engine 406 can control each switch 425 automatically (for example, based on one or more algorithms stored in the storage repository 430) and/or based on power, control, communication, and/or other similar signals received from another device (e.g., the energy metering module 413) through a communication link 409. The control engine 406 may include a printed circuit board, upon which the hardware processor 421 and/or one or more discrete components of the dynamic tuning system 404 are positioned.

In certain embodiments, the control engine 406 of the controller 429 of the dynamic tuning system 404 can communicate with one or more components of a system external to the system 400 in furtherance of harvesting energy by the energy harvesting system 402. For example, the control engine 406 can adjust a setting of a capacitor bank in order to provide more stable characteristics of power flowing through the secondary inductor 405. As another example, the control engine 406 can interact with an inventory management system by ordering a switch 425 (and/or one or more other components of the energy harvesting system 402) to replace a switch 425 (and/or one or more other components of the energy harvesting system 402) that the control engine 406 has determined to fail or be failing.

As another example, the control engine 406 can interact with a workforce scheduling system by scheduling an electrician to repair or replace the energy harvesting system 402 (or portion thereof) when the control engine 406 determines that the energy harvesting system 402 or portion thereof requires maintenance or replacement. In this way, the dynamic tuning system 404 can be capable of performing a number of functions beyond what could reasonably be considered a routine task or an abstract idea.

In certain example embodiments, the control engine 406 track the various characteristics (e.g., frequency, current, voltage) of the power flowing through the secondary inductor 405 over time and analyze those characteristics. Consequently, the control engine 406 can choose the optimal characteristic of the power at that point in time for harvesting energy for the electrical load 490. For example, if the third harmonic is dominant in the power flowing through the secondary inductor 405, then the control engine 406 can control the various switches 425 so that desired tuning capacitors 420 can be electrically coupled to the dynamic tuning system 404.

The control engine 406 can also determine if the turns ratio of the instrument transformer is optimal. If not, the control engine 406 can notify a user 450 to change to instrument transformer to another of a certain turns ratio. Alternatively, if the instrument transformer has multiple taps to change the turns ratio, the control engine 406 can change taps to achieve a more optimal turns ratio.

In certain example embodiments, the control engine 406 can include an interface that enables the control engine 406 to communicate with one or more components (e.g., energy transfer device 411, user 450, electrical load 490) of the energy harvesting system 402. Such an interface can operate in conjunction with, or independently of, the communication protocols used to communicate between the dynamic tuning system 404 and the user 450, the electrical load 490, and the secondary inductor 405.

The control engine 406 (or other components of the dynamic tuning system 404) can also include one or more hardware components and/or software elements to perform its functions. Such components can include, but are not limited to, a universal asynchronous receiver/transmitter (UART), a serial peripheral interface (SPI), a direct-attached capacity (DAC) storage device, an analog-to-digital converter, an inter-integrated circuit (I²C), and a pulse width modulator (PWM).

The communication module 408 of the controller 429 of the dynamic tuning system 404 determines and implements the communication protocol (e.g., from the communication protocols of the storage repository 430) that is used when the control engine 406 communicates with (e.g., sends signals to, receives signals from) the user 450, the electrical load 490, and/or the secondary inductor 405. In some cases, the communication module 408 accesses the stored data to determine which communication protocol is used to communicate with the user 450. In addition, the communication module 408 can interpret the communication protocol of a communication received by the dynamic tuning system 404 so that the control engine 406 can interpret the communication.

The communication module 408 can send and receive data between the electrical load 490, the secondary inductor 405, and/or the users 450 and the dynamic tuning system 404. The communication module 408 can send and/or receive data in a given format that follows a particular communication protocol. The control engine 406 can interpret the data packet received from the communication module 408 using the communication protocol information stored in the storage repository 430. The control engine 406 can also facilitate the transfer of signals between the secondary inductor 405 and the electrical load 490 or a user 450 by converting the signal into a format understood by the communication module 408.

The communication module 408 can send data (e.g., communication protocols, algorithms, stored data, operational information, alarms, control instructions for switches 425) directly to and/or retrieve data directly from the storage repository 430. Alternatively, the control engine 406 can facilitate the transfer of data between the communication module 408 and the storage repository 430. The communication module 408 can also provide encryption to data that is sent by the dynamic tuning system 404 and decryption to data that is received by the dynamic tuning system 404. The communication module 408 can also provide one or more of a number of other services with respect to data sent from and received by the dynamic tuning system 404. Such services can include, but are not limited to, data packet routing information and procedures to follow in the event of data interruption.

The real-time clock 410 of the controller 429 of the dynamic tuning system 404 can track clock time, intervals of time, an amount of time, and/or any other measure of time. The real-time clock 410 can also count the number of occurrences of an event, whether with or without respect to time. Alternatively, the control engine 406 can perform a counting function. The real-time clock 410 is able to track multiple time measurements concurrently. The real-time clock 410 can track time periods based on an instruction received from the control engine 406, based on an instruction received from the user 450, based on an instruction programmed in the software for the dynamic tuning system 404, based on some other condition or from some other component, or from any combination thereof.

The real-time clock 410 can be configured to track time when there is no power delivered to the dynamic tuning system 404 (e.g., the power module 412 malfunctions) using, for example, a super capacitor or a battery backup. In such a case, when there is a resumption of power delivery to the dynamic tuning system 404 from an external power supply, the real-time clock 410 can communicate any aspect of time to the dynamic tuning system 404. In such a case, the real-time clock 410 can include one or more of a number of components (e.g., a super capacitor, an integrated circuit, a battery) to perform these functions.

The energy metering module 413 of the controller 429 of the dynamic tuning system 404 measures one or more components of power (e.g., current, voltage, frequency, inductance, impedance, resistance, VARs, watts) at one or more points within the energy harvesting system 402. The energy metering module 413 can include any of a number of measuring devices and related devices, including but not limited to a voltmeter, an ammeter, a power meter, an ohmmeter, a current transformer, a potential transformer, a frequency counter, a LCR meter, and electrical wiring. The energy metering module 413 can measure a component of power continuously, periodically, based on the occurrence of an event, based on a command received from the control module 406, and/or based on some other factor. In some cases, the energy metering module 413 can be separate from the dynamic tuning system 404 or even the energy harvesting system 402.

The power module 412 of the controller 429 of the dynamic tuning system 404 provides power to one or more other components (e.g., real-time clock 410, control engine 406) of the dynamic tuning system 404. In addition, in certain example embodiments, the power module 412 can provide power to the energy transfer device 411 of the energy harvesting system 402. The power module 412 can include one or more of a number of single or multiple discrete components (e.g., transistor, diode, resistor, capacitor), and/or a microprocessor. The power module 412 may include a printed circuit board, upon which the microprocessor and/or one or more discrete components are positioned. In some cases, the power module 412 can include one or more components that allow the power module 412 to measure one or more elements of power (e.g., voltage, current, frequency, inductance, impedance) that that can be measured at one or more points within the energy harvesting system. In addition, or in the alternative, the power metering module 412 can measure one or more elements of power that flows into, out of, and/or within one or more portions of the dynamic tuning system 404.

The power module 412 can include one or more components (e.g., a transformer, a diode bridge, an inverter, a converter) that receives power (for example, through an electrical cable) from a source external to the energy harvesting system 402 and creates power of a type (e.g., alternating current, direct current) and level (e.g., 12V, 24V, 120V) that can be used by the other components of the dynamic tuning system 404 and/or by the energy transfer device 411. In addition, or in the alternative, the power module 412 can be a source of power in itself to provide signals to the other components of the dynamic tuning system 404 and/or the energy transfer device 411. For example, the power module 412 can be a battery. As another example, the power module 412 can be a localized photovoltaic power system. In some cases, the power module 412 can have sufficient isolation in the associated components of the power module 412 (e.g., transformers, opto-couplers, current and voltage limiting devices) so that the power module 412 is certified to provide power to an intrinsically safe circuit.

The hardware processor 421 of the dynamic tuning system 404 executes software, algorithms, and firmware in accordance with one or more example embodiments. Specifically, the hardware processor 421 can execute software on the control engine 406 or any other portion of the dynamic tuning system 404, as well as software used by the user 450, the electrical load 490, and/or the secondary inductor 405. The hardware processor 421 can be an integrated circuit, a central processing unit, a multi-core processing chip, SoC, a multi-chip module including multiple multi-core processing chips, or other hardware processor in one or more example embodiments. The hardware processor 421 is known by other names, including but not limited to a computer processor, a microprocessor, and a multi-core processor.

In one or more example embodiments, the hardware processor 421 executes software instructions stored in memory 422. The memory 422 includes one or more cache memories, main memory, and/or any other suitable type of memory. The memory 422 can include volatile and/or non-volatile memory. The memory 422 is discretely located within the controller 429 of the dynamic tuning system 404 relative to the hardware processor 421 according to some example embodiments. In certain configurations, the memory 422 can be integrated with the hardware processor 421.

As discussed above, in certain example embodiments, the dynamic tuning system 404 does not include a hardware processor 421. In such a case, the dynamic tuning system 404 can include, as an example, one or more field programmable gate arrays (FPGA). Using FPGAs and/or other similar devices known in the art allows the dynamic tuning system 404 (or portions thereof) to be programmable and function according to certain logic rules and thresholds without the use of a hardware processor. Alternatively, FPGAs and/or similar devices can be used in conjunction with one or more hardware processors 421.

The transceiver 424 of the dynamic tuning system 404 can send and/or receive control and/or communication signals. Specifically, the transceiver 424 can be used to transfer data between the dynamic tuning system 404 and the user 450, the electrical load 490, and/or the secondary inductor 405. The transceiver 424 can use wired and/or wireless technology. The transceiver 424 can be configured in such a way that the control and/or communication signals sent and/or received by the transceiver 424 can be received and/or sent by another transceiver that is part of the user 450, the electrical load 490, and/or the secondary inductor 405. The transceiver 424 can use any of a number of signal types, including but not limited to radio signals.

When the transceiver 424 uses wireless technology, any type of wireless technology can be used by the transceiver 424 in sending and receiving signals. Such wireless technology can include, but is not limited to, Wi-Fi, visible light communication, cellular networking, and Bluetooth. The transceiver 424 can use one or more of any number of suitable communication protocols (e.g., ISA100, HART) when sending and/or receiving signals. Such communication protocols can be stored in the storage repository 430. Further, any transceiver information for the user 450, the electrical load 490, and/or the secondary inductor 405 can be part of the stored data (or similar areas) of the storage repository 430.

Optionally, in one or more example embodiments, the security module 428 secures interactions between the dynamic tuning system 404, the user 450, the electrical load 490, and/or the secondary inductor 405. More specifically, the security module 428 authenticates communication from software based on security keys verifying the identity of the source of the communication. For example, user software may be associated with a security key enabling the software of the user 450 to interact with the dynamic tuning system 404, the electrical load 490, and/or the secondary inductor 405. Further, the security module 428 can restrict receipt of information, requests for information, and/or access to information in some example embodiments.

As mentioned above, aside from the dynamic tuning system 404 and its components, the energy harvesting system 402 can include an energy transfer device 411 and the main capacitor 415. The energy transfer device 411 of the energy harvesting system 402 receives power from the dynamic tuning system 404 and manipulates (e.g., transforms, inverts, converts) that power into transformed power, which is delivered to the electrical load 490. The energy transfer device 411 can include one or more of a number of energy-transforming components, including but not limited to a diode bridge, a transformer, an inverter, and a converter. The energy transfer device 411 can be substantially the same as, or different than, the power module 412 of the dynamic tuning system 404. The energy transfer device 411 can include one or more of a number of single or multiple discrete components (e.g., transistor, diode, resistor), and/or a microprocessor. The energy transfer device 411 may include a printed circuit board, upon which the microprocessor and/or one or more discrete components are positioned, and/or a dimmer.

The energy transfer device 411 can create power of a type (e.g., alternating current, direct current) and level (e.g., 12V, 24V, 120V) that can be used by the electrical load 490. In addition, or in the alternative, the energy transfer device 411 can receive power from a source external to the energy harvesting system 402. In addition, or in the alternative, the energy transfer device 411 can be a source of power in itself. For example, the energy transfer device 411 can be a battery, a localized photovoltaic power system, or some other source of independent power.

As stated above, the energy harvesting system 402 can be placed in any of a number of environments. In such a case, the housing 102 of the energy harvesting system 402 can be configured to comply with applicable standards for any of a number of environments. For example, the energy harvesting system 402 can be rated as a Division 1 or a Division 2 enclosure under NEC standards. Similarly, the secondary inductor 405, the user 450, the electrical load 490, and/or any other devices coupled to the energy harvesting system 402 can be configured to comply with applicable standards for any of a number of environments.

FIG. 5 illustrates one embodiment of a computing device 518 that implements one or more of the various techniques described herein, and which is representative, in whole or in part, of the elements described herein pursuant to certain exemplary embodiments. Computing device 518 is one example of a computing device and is not intended to suggest any limitation as to scope of use or functionality of the computing device and/or its possible architectures. Neither should computing device 518 be interpreted as having any dependency or requirement relating to any one or combination of components illustrated in the example computing device 518.

Computing device 518 includes one or more processors or processing units 514, one or more memory/storage components 519, one or more input/output (I/O) devices 516, and a bus 517 that allows the various components and devices to communicate with one another. Bus 517 represents one or more of any of several types of bus structures, including a memory bus or memory controller, a peripheral bus, an accelerated graphics port, and a processor or local bus using any of a variety of bus architectures. Bus 517 includes wired and/or wireless buses.

Memory/storage component 519 represents one or more computer storage media. Memory/storage component 519 includes volatile media (such as random access memory (RAM)) and/or nonvolatile media (such as read only memory (ROM), flash memory, optical disks, magnetic disks, and so forth). Memory/storage component 519 includes fixed media (e.g., RAM, ROM, a fixed hard drive, etc.) as well as removable media (e.g., a Flash memory drive, a removable hard drive, an optical disk, and so forth).

One or more I/O devices 516 allow a customer, utility, or other user to enter commands and information to computing device 518, and also allow information to be presented to the customer, utility, or other user and/or other components or devices. Examples of input devices include, but are not limited to, a keyboard, a cursor control device (e.g., a mouse), a microphone, a touchscreen, and a scanner. Examples of output devices include, but are not limited to, a display device (e.g., a monitor or projector), speakers, outputs to a lighting network (e.g., DMX card), a printer, and a network card.

Various techniques are described herein in the general context of software or program modules. Generally, software includes routines, programs, objects, components, data structures, and so forth that perform particular tasks or implement particular abstract data types. An implementation of these modules and techniques are stored on or transmitted across some form of computer readable media. Computer readable media is any available non-transitory medium or non-transitory media that is accessible by a computing device. By way of example, and not limitation, computer readable media includes “computer storage media”.

“Computer storage media” and “computer readable medium” include volatile and non-volatile, removable and non-removable media implemented in any method or technology for storage of information such as computer readable instructions, data structures, program modules, or other data. Computer storage media include, but are not limited to, computer recordable media such as RAM, ROM, EEPROM, flash memory or other memory technology, CD-ROM, digital versatile disks (DVD) or other optical storage, magnetic cassettes, magnetic tape, magnetic, disk storage or other magnetic storage devices, or any other medium which is used to store the desired information and which is accessible by a computer.

The computer device 518 is connected to a network (not shown) (e.g., a local area network (LAN), a wide area network (WAN) such as the Internet, cloud, or any other similar type of network) via a network interface connection (not shown) according to some exemplary embodiments. Those skilled in the art will appreciate that many different types of computer systems exist (e.g., desktop computer, a laptop computer, a personal media device, a mobile device, such as a cell phone or personal digital assistant, or any other computing system capable of executing computer readable instructions), and the aforementioned input and output means take other forms, now known or later developed, in other exemplary embodiments. Generally speaking, the computer system 518 includes at least the minimal processing, input, and/or output means necessary to practice one or more embodiments.

Further, those skilled in the art will appreciate that one or more elements of the aforementioned computer device 518 is located at a remote location and connected to the other elements over a network in certain exemplary embodiments. Further, one or more embodiments is implemented on a distributed system having one or more nodes, where each portion of the implementation (e.g., control engine 406) is located on a different node within the distributed system. In one or more embodiments, the node corresponds to a computer system. Alternatively, the node corresponds to a processor with associated physical memory in some exemplary embodiments. The node alternatively corresponds to a processor with shared memory and/or resources in some exemplary embodiments.

Example embodiments provide increased efficiency in harvesting energy for an electrical load from an instrument transformer, such as a current transformer. Example embodiments provide dynamic tuning to account for changes in one or more characteristics (e.g., frequency) of the power flowing through the instrument transformer, inconsistencies in the instrument transformer, and variations in the electrical load. Example embodiments provide a number of benefits. Examples of such benefits include, but are not limited to, reduced downtime of equipment, lower maintenance costs, increased availability of electrical equipment, improved maintenance planning, improved efficiency of one or more devices and/or other portions of an example energy harvesting system, extended useful life of one or more components of an example energy harvesting system, and reduced cost of labor and materials. Example embodiments can be used to augment existing systems, either as an add-on to the existing system or by being integrated with the existing system. Alternatively, example embodiments (or portions thereof) can be used portably and/or interchangeably. For example, different instrument transformers can be used with example embodiments at different times.

Although embodiments described herein are made with reference to example embodiments, it should be appreciated by those skilled in the art that various modifications are well within the scope and spirit of this disclosure. Those skilled in the art will appreciate that the example embodiments described herein are not limited to any specifically discussed application and that the embodiments described herein are illustrative and not restrictive. From the description of the example embodiments, equivalents of the elements shown therein will suggest themselves to those skilled in the art, and ways of constructing other embodiments using the present disclosure will suggest themselves to practitioners of the art. Therefore, the scope of the example embodiments is not limited herein.

What is claimed is:

1. An energy harvesting system, comprising:
an electrical conductor through which primary power flows;
an instrument transformer disposed around the electrical conductor, wherein the instrument transformer comprises a secondary inductor, wherein the instrument transformer creates a first transformed power through the secondary inductor using the first power,
at least one tuning capacitor electrically coupled in parallel to the secondary inductor;
at least one switch coupled in series with the at least one tuning capacitor, wherein the at least one switch has an open position and a closed position, wherein the closed position allows the at least one tuning capacitor to remain electrically coupled to the secondary inductor, and wherein the open position electrically decouples the at least one tuning capacitor from the secondary inductor; and
an electrical load electrically coupled to the secondary inductor and the at least one switch, wherein the at least one tuning capacitor modifies the first transformed power when the at least one switch is in the closed position, wherein the electrical load operates using the first transformed power.

2. The energy harvesting system of claim 1, wherein the instrument transformer is a current transformer.

3. The energy harvesting system of claim 1, wherein the at least one switch is controlled by a controller.

4. The energy harvesting system of claim 3, wherein the controller comprises a feedback circuit.

5. The energy harvesting system of claim 3, wherein the controller actively operates each of the at least one switches based on a characteristic of the first transformed power.

6. The energy harvesting system of claim 5, wherein the characteristic of the first transformed power comprises at least one selected from a group consisting of a frequency, a voltage, and a current.

7. The energy harvesting system of claim 1, wherein the electrical load comprises an energy charging device, wherein the first transformed power is used to charge the energy storage device.

8. The energy harvesting system of claim 1, further comprising:
a main capacitor electrically coupled in parallel to the secondary inductor and the at least one tuning capacitor when the at least one switch is in the closed position.

9. The energy harvesting system of claim 8, further comprising:
a charge transfer device electrically coupled to and disposed between the electrical load and a group comprising the secondary inductor, the main capacitor, and the at least one tuning capacitor, wherein the charge transfer device converts the first transformed power to a second transformed power, wherein the second transformed power is supplied to the electrical load.

10. The energy harvesting system of claim 9, wherein the charge transfer device comprises a diode bridge.

11. The energy harvesting system of claim 1, wherein the secondary inductor is wrapped around a primary inductor of the instrument transformer.

12. The energy harvesting system of claim 1, wherein the instrument transformer comprises a split core.

13. The energy harvesting system of claim 1, wherein the instrument transformer comprises a steel core.

14. A system for dynamically tuning energy harvested from an instrument transformer, comprising:
a main capacitor configured to be electrically coupled in parallel to a secondary inductor of the instrument transformer;
a first tuning capacitor electrically coupled in parallel to the main capacitor,
a first switch coupled in series with the first tuning capacitor, wherein the first switch has an open position and a closed position, wherein the closed position allows the first tuning capacitor to remain electrically coupled to the main capacitor, and wherein the open position electrically decouples the first tuning capacitor from the main capacitor,
wherein the main capacitor and the secondary inductor create a first transformed voltage delivered to an electrical load, and
wherein the main capacitor, the first tuning capacitor, and the secondary inductor create a second transformed voltage delivered to the electrical load.

15. The system of claim 14, further comprising:
a controller that changes a state of the first tuning capacitor between the open state and the closed state based on a power characteristic.

16. The system of claim 15, wherein the power characteristic comprises a largest magnitude harmonic frequency in the secondary inductor.

17. The system of claim 16, wherein the controller comprises a hardware processor.

18. The system of claim 14, further comprising:
a second tuning capacitor electrically coupled in parallel to the main capacitor and the first tuning capacitor,
a second switch coupled in series with the second tuning capacitor, wherein the second switch has the open position and the closed position, wherein the closed position allows the second tuning capacitor to remain electrically coupled to the main capacitor, and wherein the open position electrically decouples the second tuning capacitor from the main capacitor,
wherein the second tuning capacitor comprises at least one tuning inductor.

19. The system of claim 18, wherein the first switch and the second switch operate independently of each other.

20. A dynamic tuning system, comprising:
at least one tuning capacitor configured to be electrically coupled in parallel to a secondary inductor and an energy transfer device, wherein the secondary inductor is part of an instrument transformer disposed around an electrical conductor through which primary power flows, wherein the instrument transformer creates a transformed power through the secondary inductor using the first power, and
at least one switch coupled in series with the at least one tuning capacitor, wherein the at least one switch has an open position and a closed position, wherein the closed position allows the at least one tuning capacitor to remain electrically coupled to the secondary inductor, and wherein the open position electrically decouples the at least one tuning capacitor from the secondary inductor,
wherein the energy transfer device processes the first transformed power as modified by the at least one tuning capacitor, and
wherein the at least one switch operates between the closed position and the open position based on at least one characteristic of the transformed power.
